(19) United States
(12) Patent Application Publication
(10) Pub. No.: US 2011/0005863 A1
(43) Pub. Date: Jan. 13, 2011

(54) PROTECTIVE ARTICLE AND A LADDER HAVING A PROTECTIVE ARTICLE

(76) Inventor: Keith L. THURNER, Monongahela, PA (US)

Correspondence Address: MCNEES WALLACE & NURICK LLC, 100 PINE STREET, P.O. BOX 1166, HARRISBURG, PA, 17108-1166, US

(21) Appl. No.: 12/829,475

(22) Filed: Jul. 2, 2010

Related U.S. Application Data
(60) Provisional application No. 61/224,201, filed on Jul. 9, 2009.

(51) Int. Cl. E06C 5/44; E06C 7/00

(52) U.S. Cl. 182/129; 182/230

(57) ABSTRACT

A protective article and a ladder having a protective article with a body and an adjustable securing feature to attach the protective article to the ladder to cushion against impact by a user is disclosed.

### PRIORITY

This application claims priority and benefit of U.S. Provisional Patent Application No. 61/224,201, filed Jul. 9, 2009, which is hereby incorporated by reference in its entirety.

### FIELD OF THE INVENTION

The present invention relates to a protective article and a ladder having a protective article. More specifically, the present invention relates to a protective article and a ladder having a protective article for preventing contact with the ladder by a user.

### BACKGROUND OF THE INVENTION

When using a ladder, a user typically stands on a rung of the ladder and then stabilizes themselves with their legs or shins on one or more of the other ladder rungs. By contacting their legs or shins against one or more of the ladder rungs, the user is provided with additional support and balance, thus allowing them to free up one or both hands to perform other tasks (for example, replacing a light bulb, painting the ceiling, removing leaves from a rain gutter, etc.).

Ladders are generally made of strong, rigid materials including, but not limited to wood, steel, aluminum, and fiberglass in order to support the weight of the user along with his or her tools and equipment. Due to the rigid nature of the ladder rungs, users bracing their unprotected shin or legs against the rungs of the ladder may find it uncomfortable. This discomfort may cause a user to take more frequent breaks to alleviate the discomfort. The discomfort may also cause the user to constantly shift or reposition themselves while working on the ladder, creating a hazardous situation where the user may slip or lose their balance.

Moreover, certain tasks may require the user to make repeated assents and descents up and down the ladder or require the user to perform tasks on the ladder where the user may inadvertently strike their arms, legs or other body parts against the rigid ladder. The lack of a barrier to provide protection may cause the user to sustain injuries such as bruises or abrasions.

Additionally, ladders are often transported between worksites and requires a user to haul the ladder between locations. Often users will balance the rigid surfaces of a ladder over their shoulders, resulting in pain or discomfort.

What is needed is a protective article and ladder having a protective article that protects a user.

### SUMMARY OF THE INVENTION

One aspect of the present disclosure includes a protective article for use with a ladder. The protective article includes a body to reduce or eliminate contact with the ladder by a user and an adjustable securing feature. The adjustable securing feature is configured to secure the body to a portion of the ladder.

Another aspect of the present disclosure includes a protective article for use with a ladder rung. The protective article includes a body to reduce or eliminate contact by a user with the ladder rung, an adjustable securing feature configured to secure the body to the ladder rung, and a covering that encloses the body to cover an exterior surface of the body. The body is made of a material capable of deforming.

Another aspect of the present disclosure includes a ladder assembly having a protective article. The ladder assembly includes a ladder and a protective article. The ladder has a plurality of ladder sections including paired uprights and a plurality of ladder rungs. The protective article has a body to reduce or eliminate contact with at least one portion of the ladder and an adjustable securing feature configured to secure the body to the ladder. The body is made of a material capable of deforming.

An advantage of the present disclosure includes providing users with comfort and additional grip while they are braced against the ladder.

Another advantage of the present disclosure is to provide protection against injuries from forceful strikes between the user and the ladder.

Yet another advantage of the present disclosure is to provide a protective barrier to reduce or eliminate wear and tear on the portion of the ladder that the protective article is secured to.

Other features and advantages of the present disclosure will be apparent from the following detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a protective article secured to a ladder with an adjustable securing feature according to an exemplary embodiment of the disclosure.

FIG. 2 is a front view of a protective article secured to the ladder according to an exemplary embodiment of the disclosure.

FIG. 3 is a section view of a user on the ladder with a protective article installed on the ladder according to an exemplary embodiment of the disclosure.

FIG. 4 is a rear view of the body with the securing feature according to an exemplary embodiment of the disclosure.

FIG. 5 is a rear view of the protective article secured to the ladder with an another securing feature according to an exemplary embodiment of the disclosure.

FIG. 6 is a section view of the protective article secured to the ladder with the another securing feature according to an exemplary embodiment of the disclosure.

### DETAILED DESCRIPTION OF THE INVENTION

Provided is a protective article 11 for use with a ladder 10 to provide cushioning support, comfort, and protection to ladder users. One aspect of the present can include the protective article 11 including a body 12 to prevent contact with the ladder 10 and an adjustable securing feature 16 for securing the body 12 to the ladder 10. The adjustable securing feature 16 can be attached to an exterior surface of the body 12. Alternatively, the protective article 11 can be provided with a covering 14 and the adjustable securing feature 16 can be attached to an exterior surface of the covering 14.

Embodiments of the present disclosure can provide users with comfort and additional grip while they are braced against the ladder 10, provide protection against injuries from forceful strikes between the user and the ladder 10, and/or provide a protective barrier to reduce or eliminate wear and tear on the portion of the ladder 10 that the protective article 11 is secured to.

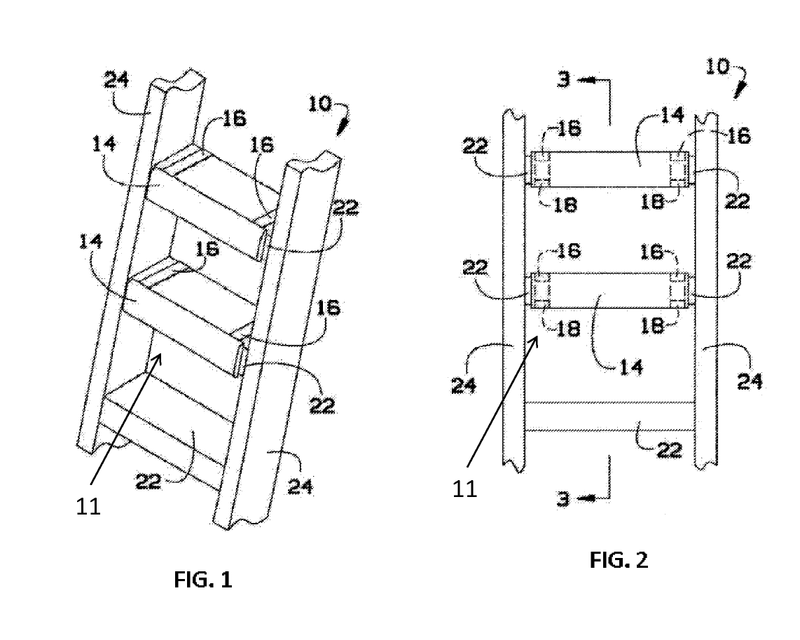

Referring to FIGS. 1-2, the protective article 11 can be a cushioning protective article. Protective article 11 can include body 12 and adjustable securing feature 16 to secure body 12 to the ladder 10. Protective article 11 can provide protection and comfort to a user of the ladder 10 or protection to the ladder 10.

The ladder 10 can be any suitable form of ladder. For example, as illustrated in FIGS. 1-2, the ladder 10 can include a plurality of ladder sections including paired vertical uprights 24 and a plurality of ladder rungs 22. The ladder 10 can also be any other form of ladder 10, including, but not limited to fixed ladders, telescopic ladders, step ladders, folding ladders, platform steps, orchard ladders, chicken ladders, hook ladders, turntable ladders, and bridge ladders. The ladder 10 can be made of strong, rigid materials including, but not limited to, wood, steel, aluminum, fiberglass, and combinations thereof. The ladder 10 can also include other features including, but not limited to, ladder stabilizers, ladder standoffs, hooks, trays, attachments, and pulley systems. To correspond to ladders 10 of different sizes, shapes, and designs, the protective article 11, can be made in any suitable predetermined length, width, and thickness to accommodate the different types and sizes of ladders 10 and/or the adjustable securing feature 16 can permit the protective article 11 to be secured to different sizes and shapes of ladders 10.

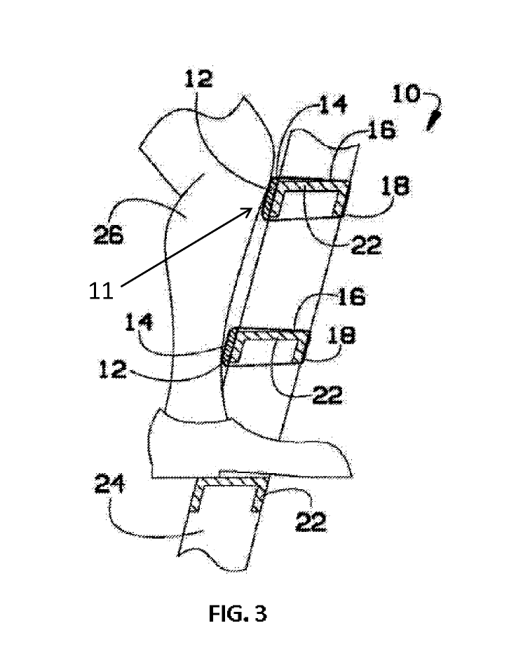

As illustrated in FIG. 3, the ladder rung 22 can a be U-shaped structure with a planar top surface for a user 26 to step on. The ladder rung 22 can be of any suitable shape including, but not limited to, tubular, cylindrical, rectangular, and combinations thereof. The ladder rung 22 can have a top planar surface for the user 26 to step on. The ladder rung 22 can be made of the same material as the vertical uprights 24, also known as stringers or stiles, or they can be made of different materials. The ladder rung 22 can be arranged such that knees, shins, and/or other body parts of the user 26 contact the protective article 11 proximal to a first ladder rung 22 when the user 26 is standing upon on the ground or on a second ladder rung 22.

The body 12 of the protective article 11 can be attached to a front surface of the ladder rung 22 (for example, a surface proximal to the user 26 during regular use). The body 12 can be positioned where the knee or shin of the user 26 normally contacts the ladder rung 22 (see FIG. 3). The body 12 can be made of a material capable of deforming and comfortably supporting the user 26. For example, the body 12 can be made of any suitable deformable material or substance, including but not limited to, a liquid, a foam material, an elastomeric material, or a gel material. In one embodiment, the body 12 includes at least one chamfered corner edge. By attaching the protective article 11 to the ladder 10, the body 12 can provide a cushioning barrier between the ladder rung 22 of the ladder 10 and the user 26. Additionally or alternatively, the body 12 can protect the ladder 10 against impacts from tools and/or falling debris.

In one embodiment, the body 12 is sized to substantially cover one surface of the ladder 10. In this embodiment, the body 12 can provide protection and comfort when the user 26 contacts the surface. Additionally, the body 12 can be sized to substantially cover additional surfaces. In another embodiment, the body 12 can be large enough to cushion the user 26, but small enough not to interfere or trip the user 26 while moving up and down the ladder 10. In one embodiment, the body 12 includes a length of up to sixteen-inches, a width of up to four-inches, and a thickness of at least one-inch. In another embodiment, the body 12 includes a length of between twelve and sixteen-inches, a width of between two and four-inches, and a thickness of between one-inch and two-inches.

The adjustable securing feature 16 of the body 12 can secure the protective article 11 to a portion the ladder 10. In one embodiment, the portion of the ladder 10 is the ladder rung 22. In other embodiments, the adjustable securing feature 16 can secure the protective article 11 to the uprights 24, scaffoldings, railings, utility buckets on trucks, and/or other suitable structures. In one embodiment, the adjustability of adjustable securing feature 16 permits protective article 11 to be utilized with a ladder rung and/or a second ladder rung having different sizes and/or shapes.

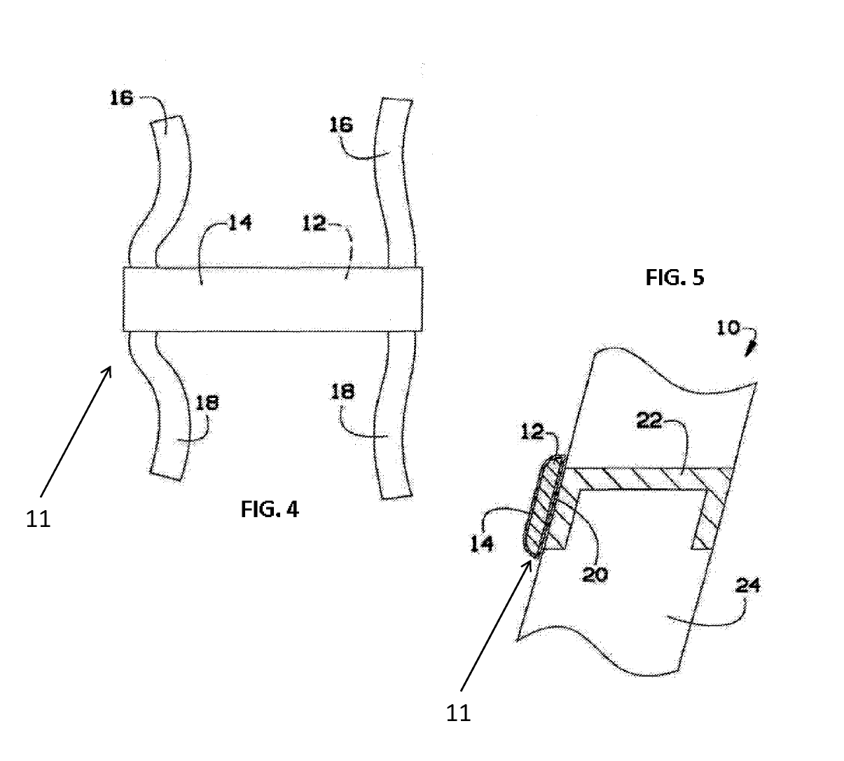

As illustrated in FIG. 4, the adjustable securing feature 16 of the protective article 11 can be attached to the body 12. In this embodiment, the adjustable securing feature 16 includes a plurality of hook and loop type straps. The adjustable securing feature 16 of the protective article 11 can also be attached to an exterior surface of the body 12. The use of hook and loop type straps permits protective article 11 to be attached and removed from a variety of ladders 10. In an alternate embodiment, protective article 11 further comprises a covering 14 that encloses body 12. In this embodiment, adjustable securing feature 16 is attached to an exterior surface of covering 14 and secured to ladder 10. In yet another embodiment, as illustrated in FIG. 5, adjustable securing feature 20 includes an adhesive strip.

The hook and loop type straps of adjustable securing feature 16 can be long enough to wrap around the ladder rung 22 and/or to reduce or prevent unintended disengagement. The hook and loop type straps can be wide enough to support the weight of protective article 11. The size of the hook and loop type straps can be selected to reduce or eliminate movement of protective article 11 when the user 26 rubs up against protective article 11. In one embodiment, one of the hook and loop type straps is positioned at a first longitudinal end of body 12, and a second of the hook and loop type straps is positioned at a second longitudinal end of body 12.

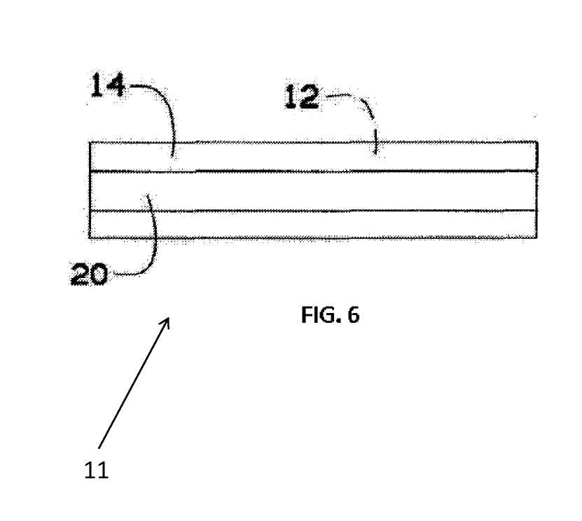

The adjustable securing feature 20 including an adhesive strip, as illustrated in FIG. 6, can include adhesives with a strong enough bond to retain the protective article 11 on the ladder 10. Additionally or alternatively, the type, size, and/or amount of the adhesive can reduce or eliminate movement of the protective article 11 when the user 26 rubs up against the protective article 11.

In one embodiment, when the covering 14 is included, the adjustable securing feature 20 including an adhesive strip is attached to the exterior surface of the covering 14 by sewing. In another embodiment, the adjustable securing feature 20 including an adhesive strip is attached to an exterior surface of the body 12 and the ladder 10. The covering 14 can be made of materials including, but not limited to, vinyl, polyester, cotton, nylon, spandex, wool, silk, linen, canvas, and blends thereof. In another embodiment, the covering 14 can be made of the same material as the body 12 or can be unitary with the body 12. In one embodiment, the covering 14 can include an image for displaying corporate logos, advertising, aesthetic designs, and the like. In another embodiment, the covering 14 can also be stain resistant in order for the article 11 to maintain a clean appearance and also aid in the removal of any stains that may accumulate.

In one embodiment, the covering 14 can include a grip material (for example, a silicon grip material) secured to an exposed exterior surface of the covering 14 to provide additional grip and traction between the protective article 11 and the user 26. The additional grip provided can be desirable for resting legs, shins, and/or other body parts of the user 26 against the protective article 11. This can permit arms and hands of the user 26 to be used for other tasks.

The protective article 11 may be sized or modular to accommodate ladders 10 of different sizes. In one embodiment, the protective article 11 may be a predetermined size and trimmed down to a desired size. In one embodiment, the size of the body 12 is approximately the length and width of the ladder rung 22. In another embodiment, the length of the body 12 is shorter than the length of the ladder rung 22. In another embodiment, the width of the body 12 is longer than the width of the ladder rung 22.

In one further embodiment where the protective article 11 is modular and the covering 14 of a first protective article 11 includes an attachment feature (not shown). The attachment feature is attachable to the covering 14 of a second protective article 11 that is modular. The attachment feature can be any suitable attachment feature (for example, a hook and loop closure, zipper, buttons, snaps, buckles, or laces). In one embodiment, the body 12 and the covering 14 of the first protective article is four-inches wide, and the body 12 and covering 14 of the second protective article is six-inches wide. When the first protective article is mated with the second protective article, a united protective article of ten-inches wide is formed. The mating of multiple protective articles 11, whether they are the same width or not, provides the ability to create custom lengths of cushioning support for differently sized ladders.

In another further embodiment where the protective article 11 is modular, the covering 14 has a first length and body pieces (not illustrated) have a second length. The first length is greater than the second length. In one embodiment, the covering 14 is sixteen-inches in length while the body pieces are four-inches in length. When four body pieces are utilized and inserted into the covering 14, the protective article 11 provides approximately sixteen-inches of cushioning support. In another embodiment, only three body pieces are utilized and inserted into the covering 14. In this embodiment, the protective article 11 provides approximately twelve-inches of cushioning support. Alternatively, single body pieces of multiple lengths may be inserted into the covering 14 individually to obtain different widths for the protective article 11. The excess covering length can be cut off, folded over, tucked away, or otherwise reduced behind the non-exposed exterior surface of the covering 14. The covering 14 can include a closure feature that enables the covering 14 to be opened, body pieces to be inserted or removed, and/or the covering 14 can be closed off to prevent body pieces from falling out. The closure feature can be a hook and loop closure, zipper, buttons, snaps, buckles, or laces.

While the invention has been described with reference to a preferred embodiment, it will be understood by those skilled in the art that various changes may be made and equivalents may be substituted for elements thereof without departing from the scope of the invention. In addition, many modifications may be made to adapt a particular application or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A protective article for use with a ladder, the protective article comprising:
a body to reduce or eliminate contact with the ladder by a user; and
an adjustable securing feature;
wherein the adjustable securing feature is configured to secure the body to a portion of the ladder.

2. The protective article of claim 1, wherein the portion of the ladder is a ladder rung.

3. The protective article of claim 2, wherein the adjustability of the adjustable securing feature permits the protective article to be utilized with the ladder rung or a second ladder rung having a different size or shape.

4. The protective article of claim 1, wherein the protective article is modular.

5. The protective article of claim 1, further comprising a covering that encloses the body to cover an exterior surface of the body.

6. The protective article of claim 5, wherein the covering includes an image.

7. The protective article of claim 5, wherein the covering is stain resistant.

8. The protective article of claim 5, wherein the adjustable securing feature is attached to an exterior surface of the covering and secured to the portion of the ladder.

9. The protective article of claim 5, wherein the covering comprises a material selected from the group consisting of vinyl, polyester, cotton, nylon, spandex, wool, silk, linen, canvas, and blends thereof.

10. The protective article of claim 5, wherein the covering and the body comprise an identical material.

11. The protective article of claim 5, wherein the covering further comprises a grip material to prevent relative movement between the body and the ladder.

12. The protective article of claim 1, wherein the adjustable securing feature includes an adhesive strip.

13. The protective article of claim 1, wherein the body includes at least one chamfered corner edge.

14. The protective article of claim 1, wherein the body is made of a material capable of deforming and comfortably supporting a user.

15. A ladder assembly including the ladder and the protective article of claim 1.

16. A protective article for use with a ladder rung, the protective article comprising:
a body to reduce or eliminate contact by a user with the ladder rung;
an adjustable securing feature configured to secure the body to the ladder rung; and
a covering that encloses the body to cover an exterior surface of the body;
wherein the body is made of a material capable of deforming.

17. The protective article of claim 16, wherein the protective article is modular.

18. The protective article of claim 16, wherein the adjustability of the adjustable securing feature permits the protective article to be utilized with the ladder rung or a second ladder rung having a different size or shape.

19. A ladder assembly having a protective article, the ladder assembly comprising:
a ladder having a plurality of ladder sections including paired uprights and a plurality of ladder rungs;
a protective article having a body to reduce or eliminate contact with at least one portion of the ladder and an adjustable securing feature configured to secure the body to the ladder;
wherein the body is made of a material capable of deforming.

20. The ladder assembly of claim 19, wherein the at least one portion of the ladder is a ladder rung and wherein the adjustability of the adjustable securing feature permits the protective article to be utilized with the ladder rung or a second ladder rung having a different size or shape.
